(19) United States
(12) Patent Application Publication
(10) Pub. No.: US 2025/0244613 A1
(43) Pub. Date: Jul. 31, 2025

(54) Foveated Lenses

(71) Applicant: Apple Inc., Cupertino, CA (US)

(72) Inventors: Patrick R. Gill, Victoria (CA); Yu Horie, San Jose, CA (US); Laura L. Walker, Orinda, CA (US); Jian Xing, Santa Clara, CA (US)

(21) Appl. No.: 18/985,573

(22) Filed: Dec. 18, 2024

Related U.S. Application Data
(60) Provisional application No. 63/626,894, filed on Jan. 30, 2024.

(51) Int. Cl. G02C 7/08; G02C 7/06; G02F 1/29

(52) U.S. Cl. CPC G02C 7/083; G02C 7/06; G02F 1/294

(57) ABSTRACT

A pair of eyeglasses may include one or more adjustable lenses. Each adjustable lens may include a switchable liquid crystal diffuser or an array of adjustable microlenses. The switchable diffuser may have a clear foveated region surrounded by a diffused peripheral region that reduces contrast in a user's peripheral vision to help slow myopic progression. The switchable diffuser may include liquid crystal material interposed between a blanket common electrode and an array of finger electrodes or interposed between first and second sets of orthogonal electrode arrays. The eyeglasses may include a gaze tracking sensor that tracks a user's gaze. The clear foveated region may shift to remain aligned with the user's gaze. In a microlens array arrangement, microlenses in the gaze region may pass light unaltered, while microlenses in the peripheral region may refract and refocus light in front of the retina to help slow myopic progression.

This application claims the benefit of provisional patent application No. 63/626,894, filed Jan. 30, 2024, which is hereby incorporated by reference herein in its entirety.

### BACKGROUND

This relates generally to optical systems, and, more particularly, to devices with foveated lenses.

Eyewear may include optical systems such as lenses. For example, eyewear such as a pair of glasses may include lenses that allow users to view the surrounding environment.

It can be challenging to design devices such as these. If care is not taken, the optical systems in these devices may not be able to accommodate different vision conditions and may not perform satisfactorily.

### SUMMARY

Eyeglasses may be worn by a user and may include one or more adjustable lenses each aligned with a respective one of a user's eyes. For example, a first adjustable lens may align with the user's left eye and a second adjustable lens may align with the user's right eye. Each adjustable lens may include a switchable diffuser formed from liquid crystal material or may include an array of adjustable microlenses. The switchable diffuser may have a clear foveated region aligned with the user's gaze and surrounded by a diffused (e.g., reduced contrast) peripheral region. In a microlens array, microlenses in the gaze region may leave light unchanged while microlenses in the peripheral region may be adjusted to refract and refocus light in front of the retina. Reducing contrast and/or introducing myopic defocus in the user's peripheral vision may help slow myopic progression.

Each of the first and second adjustable lenses may include one or more liquid crystal cells or other voltage-modulated optical material. Each liquid crystal cell may include a layer of liquid crystal material interposed between transparent substrates. Control circuitry may apply control signals to an array of electrodes in the liquid crystal cell to adjust a phase profile of the liquid crystal material. The liquid crystal material may be interposed between a blanket common electrode and an array of finger electrodes, or the liquid crystal material may be sandwiched between first and second sets of orthogonal electrode arrays in a passive matrix addressing scheme. Arrangements in which the liquid crystal is interposed between a blanket common electrode and an array of pixelated electrodes (e.g., rectangular electrodes, hexagonal electrodes, circular electrodes, and/or other pixelated electrodes) may also be used. The liquid crystal material may preferentially diffuse and/or refocus light in a specific direction such as a radial direction or a tangential direction to help focus peripheral light in front of the retina. The liquid crystal material may, if desired, exhibit high dispersion to diffuse and/or refocus blue light more than red light in the peripheral region.

Liquid crystal materials are herein used by way of an example of an electrically modulated optical material. Other electrically modulated optical materials can be used in place of the liquid crystals described herein.

### BRIEF DESCRIPTION OF THE DRAWINGS

FIG. 1 is a diagram of illustrative system that includes eyeglasses with foveated lenses in accordance with an embodiment.

FIG. 2 is a perspective view of a foveated lens system in accordance with an embodiment.

FIG. 3 is a side view of an illustrative liquid crystal cell that may be used to form a foveated lens in accordance with an embodiment.

FIG. 4 is a side view of an illustrative liquid crystal module having first and second liquid crystal layers with antiparallel liquid crystal alignment orientations in accordance with an embodiment.

FIG. 5 is a perspective view of an illustrative stack of liquid crystal cells having different electrode orientations in accordance with an embodiment.

FIG. 6 is a graph showing an illustrative voltage profile that may be applied across a liquid crystal cell to produce a clear foveated region and a diffused peripheral region in accordance with an embodiment.

FIG. 7 is a perspective view of an illustrative liquid crystal cell having a passive matrix array in accordance with an embodiment.

FIG. 8 is a graph showing illustrative voltage profiles that may be applied to a passive matrix array of a liquid crystal cell to produce a clear foveated region and a diffused peripheral region in accordance with an embodiment.

FIG. 9 is a side view of an illustrative polymer-dispersed liquid crystal cell that may be used to form a foveated lens in accordance with an embodiment.

FIG. 10 is a side view of an illustrative array of adjustable microlenses that may be used to form a foveated lens in accordance with an embodiment.

FIG. 11 is a side view of the microlens array of FIG. 10 showing how a clear foveated region may shift to a different region of the microlens array to remain aligned with a gaze location in accordance with an embodiment.

### DETAILED DESCRIPTION

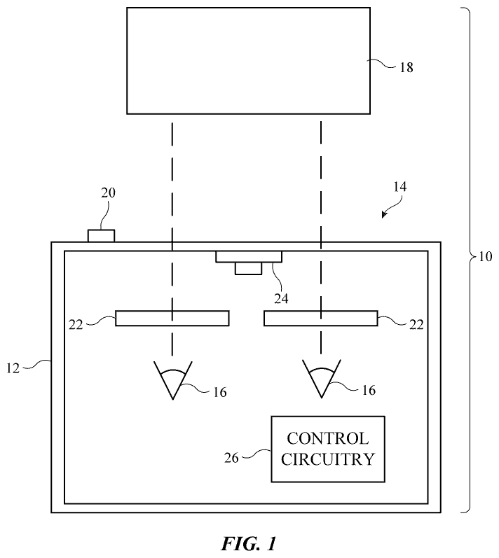

An illustrative system having a device with one or more electrically adjustable optical elements is shown in FIG. 1. System 10 may include a head-mounted device such as eyeglasses 14 (sometimes referred to as glasses 14). Glasses 14 may include one or more optical systems such as adjustable lens components 22 mounted in a support structure such as support structure 12. Structure 12 may have the shape of a pair of eyeglasses (e.g., with independent supporting frames or a single common support frame), may have the shape of goggles, may form a housing having a helmet shape, or may have other configurations to help in mounting and securing the components of glasses 14 on the head of a user.

Adjustable lens components 22 may form lenses that allow a viewer (e.g., a viewer having eyes 16) to view external objects such as object 18 in the surrounding environment. Glasses 14 may include one or more adjustable lens components 22, each aligned with a respective one of a user's eyes 16. As an example, lens components 22 may include a left lens 22 aligned with a viewer's left eye and may include a right lens 22 aligned with a viewer's right eye. This is, however, merely illustrative. If desired, glasses 14 may include adjustable lens components 22 for a single eye.

Eyeball elongation has been shown to be one of the primary mechanisms for myopia progression in users. Adjustable lenses 22 may be configured to modify light that reaches eyes 16 to slow or halt eyeball elongation and thereby slow or halt myopia progression. In particular, adjustable lenses 22 may include an electrically modulated optical material such as liquid crystal material that diffuses light in a user's peripheral vision while maintaining a clear foveated region that aligns with the user's gaze. In another arrangement, an array of adjustable microlenses may be used to introduce myopic defocus at the peripheral retina while leaving the foveated gaze region unchanged. If desired, the diffusion profile and/or the amount of defocus may be tapered from the peripheral region to the foveated region.

If desired, lenses 22 may include one or more lenses for correcting vision defects. For example, eyes 16 may have vision defects such as myopia, hyperopia, presbyopia, astigmatism, higher-order aberrations, and/or other vision defects. Corrective lenses such as lenses 22 may be configured to correct for these vision defects. Lenses 22 may be adjustable to accommodate users with different vision defects and/or to accommodate different focal ranges. For example, lenses 22 may have a first set of optical characteristics for a first user having a first prescription and a second set of optical characteristics for a second user having a second prescription. Lenses 22 that are used for vision correction may be combined or stacked with lenses 22 that diffuse or refocus light in a user's peripheral vision for slowing myopic progression, if desired. Glasses 14 may be used purely for vision correction (e.g., glasses 14 may be a pair of spectacles) or glasses 14 may include displays that display virtual reality or augmented reality content (e.g., glasses 14 may be a head-mounted display). In virtual reality or augmented reality systems, adjustable lens components 22 may be used to move content between focal planes from the perspective of the user. Arrangements in which glasses 14 are spectacles that do not include displays are sometimes described herein as an illustrative example. If desired, glasses 14 may include a tint layer in each lens 22 that reduces the brightness of ambient light reaching the user's eyes (e.g., glasses 14 may be sunglasses for outdoor use, if desired).

Glasses 14 may include control circuitry 26. Control circuitry 26 may include processing circuitry such as microprocessors, digital signal processors, microcontrollers, baseband processors, image processors, application-specific integrated circuits with processing circuitry, and/or other processing circuitry and may include random-access memory, read-only memory, flash storage, hard disk storage, and/or other storage (e.g., a non-transitory storage media for storing computer instructions for software that runs on control circuitry 26).

If desired, control circuitry 26 may include one or more energy storage devices such as one or more batteries and capacitors. Energy storage devices in eyeglasses 14 may be charged via a wired connection or, if desired, eyeglasses 14 may charge energy storage devices using wirelessly received power (e.g., inductive wireless power transfer, using capacitive wireless power transfer, and/or other wireless power transfer configurations).

Glasses 14 may include input-output circuitry such as eye state sensors, range finders disposed to measure the distance to external object 18, touch sensors, buttons, microphones to gather voice input and other input, sensors, and other devices that gather input (e.g., user input from viewer 16) and may include light-emitting diodes, displays, speakers, and other devices for providing output (e.g., output for viewer 16). Glasses 14 may, if desired, include wireless circuitry and/or other circuitry to support communications with a computer or other external equipment. Glasses 14 may include one or more sensors for gathering input during use of glasses 14. Sensors in glasses 14 may include an accelerometer, compass, an ambient light sensor or other light detector, a proximity sensor, a scanning laser system, and other sensors for gathering input during use of glasses 14.

Gaze tracking system 24 may be used to track a user's eyes 16. For example, gaze tracking system 24 may include one or more digital image sensors, lidar (light detection and ranging) sensors, light-emitting diodes, light sensors, ultrasound sensors, or other suitable sensors for tracking the location of a user's eyes. As an example, gaze tracking system 24 may be used by control circuitry 26 to gather images of the pupils and other portions of the eyes of the viewer. The locations of the viewer's pupils and the locations of the viewer's pupils relative to specular glints from light sources with known positions or the rest of the viewer's eyes may be used to determine the locations of the centers of the viewer's eyes (i.e., the centers of the user's pupils) and the direction of view (gaze direction) of the viewer's eyes. If desired, gaze tracking system 24 may use a three-dimensional model of the eye to help track gaze direction. In some arrangements, glasses 14 may include a wavefront sensor that measures the aberrations of a user's eyes. Control circuitry 26 may then adjust the optical properties of lens component 22 to correct the user-specific aberrations detected by the wavefront sensor. Arrangements in which glasses 14 include a sensor for measuring axial elongation of the eye (e.g., an ultrasonic sensor, a sensor based on optical coherence tomography, and/or any other suitable sensor configured to measure eyeball length) may also be used.

Control circuitry 26 may also control the operation of optical elements such as adjustable lens components 22. Adjustable lens components 22, which may sometimes be referred to as adjustable lenses, foveated lenses, adjustable lens systems, adjustable optical systems, adjustable lens devices, tunable lenses, fluid-filled variable lenses, etc., may contain electrically adjustable material such as liquid crystal material, volume Bragg gratings, adjustable microlenses, or other electrically modulated material that may be adjusted to produce customized lenses. In a diffuser arrangement, each of components 22 may contain an array of electrodes that apply electric fields to portions of a layer of liquid crystal material or other voltage-modulated optical material with an electrically adjustable index of refraction (sometimes referred to as an adjustable lens power or adjustable phase profile). By adjusting the voltages of signals applied to the electrodes, the index of refraction profile of components 22 may be dynamically adjusted. For example, control circuitry 26 may apply an appropriate voltage profile across lenses 22 to create a clear foveated region that aligns with the user's gaze (e.g., based on information from gaze tracking sensor 24) and a diffused peripheral region outside of the clear foveated region. By diffusing light in the user's peripheral vision, lenses 22 may be configured to slow myopic progression for the user. In a microlens array arrangement, control circuitry 26 may adjust microlenses in a user's peripheral vision to refocus (e.g., refract) light to a point in front of the retina, while microlenses in the gaze region may transmit light unchanged. This type of myopic defocus is another mechanism that can help slow myopic growth.

If desired, the liquid crystal material of lenses 22 may be configured to refract light in a preferential direction such as a radial direction or a tangential direction, depending on which direction is more likely to focus light in front of the retina. By preferentially refracting light in a direction that focuses light in front of the retina, the eye may take this as a signal to stop growing, which can help slow the progression of myopia. This is, however, merely illustrative. If desired, the liquid crystal material of lenses 22 may be configured to refract light in all different orientations without preferring any one particular orientation.

In some arrangements, the liquid crystal material of lenses 22 may be a high dispersion liquid crystal material that exhibits differential refraction and/or that diffuses different spectral bands by different amounts. For example, the liquid crystal material of lenses 22 may diffuse or refract blue light more than red light to help slow myopic progression. In particular, in-focus blue light may be a signal that the eyeball needs to grow. By diffusing blue light more than red light in a user's peripheral vision, lenses 22 can signal to the eye that the eyeball can stop growing. Polymer-dispersed liquid crystal material having liquid crystal droplets that are smaller (e.g., closer to blue wavelengths than red wavelengths) may exhibit greater diffusion for blue light than for red light, for example. This type of material may therefore be used to help diffuse or refocus blue light in the user's peripheral vision and slow myopic progression, while still allowing the user to see in-focus red light in the user's peripheral vision. This type of arrangement may be less visually distracting for people interacting with the user wearing glasses 14. This is, however, merely illustrative. If desired, lenses 22 may not exhibit high dispersion and blue and red light in the user's peripheral vision may be equally diffused to help slow myopic progression. Arrangements in which lenses 22 diffuse or refract red light more than blue light may also be used, if desired.

Control circuitry 26 may also, if desired, adjust lenses 22 based on information from one or more sensors such as sensor 20. Sensor 20 may be a visible light camera, an infrared camera, a depth sensor, an ambient light sensor, a location sensor, or other suitable sensor. Sensor 20 may provide information that may be used to change the operational mode of lenses 22. In particular, lens 22 may operate in a first mode in which lens 22 is entirely clear from edge to edge (e.g., without any diffused or otherwise altered regions) and a second mode in which most of lens 22 diffuses or refocuses light while a small foveated region that aligns with the user's gaze remains clear. The first mode (in which lenses 22 are entirely clear) may be useful when a user is outside (and therefore less vulnerable to myopic progression), when a user is talking to a person (and therefore desiring a more conversation-appropriate appearance), and/or when a user is looking at objects at a distance (as opposed to up close). The second mode (in which the peripheral region of lenses 22 diffuses or refocuses light while the gaze region of lenses 22 remains clear) may be useful when a user is looking at objects up close. Control circuitry 26 may monitor sensor 20 for trigger conditions (e.g., whether the user is outside, how far away the user's eyes are focused, whether the user is talking to a person, etc.) indicating whether to operate lenses 22 in the first mode or the second mode.

If desired, control circuitry 26 may monitor sensors such as sensor 20 to determine how much time a user typically spends viewing near distance objects versus how much time the user typically spends viewing far distance objects. As another example, sensors 20 may monitor how much indoor light a user is exposed to versus how much outdoor light the user is exposed to. This type of information may be indicative of how severe the user's myopia progression is likely to be, which can in turn be used to determine how much diffusion and/or peripheral defocus is needed for a particular user.

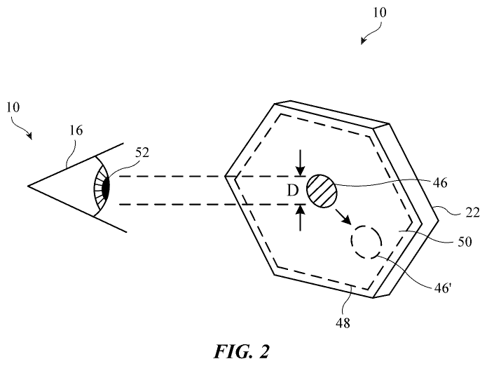

As shown in FIG. 2, for example, adjustable lens component 22 may have an active area such as active area 48. Within active area 48, adjustable lens components 22 may include one or more materials having an electrically adjustable index of refraction (e.g., liquid crystal material). Control circuitry 26 may dynamically adjust the phase profile of lens components 22. Active area 48 may include gaze area 46 and peripheral area 50. Gaze area 46 corresponds to the portions of lens components 22 that are within the user's gaze, whereas peripheral area 50 corresponds to the portions of lens components 22 that are outside of the user's gaze (e.g., portions of lens components 22 that are in the user's peripheral vision). Gaze area 46 of lens components 22 may be provided with a different phase profile than peripheral area 50. For example, gaze area 46 may be electrically modulated to produce clear (undiffused) lenses. Peripheral area 50 may be electrically modulated to produce an optical diffuser that reduces the user's peripheral contrast (e.g., that reduces the contrast of light passing through peripheral area 50 relative to light passing through gaze area 46) or may include an array of microlenses that introduces myopic defocus in the user's peripheral vision to help slow myopic progression. If desired, the diffusion profile may be tapered from peripheral region 50 to gaze region 46 (e.g., the amount of diffusion may gradually decrease from peripheral region 50 to gaze region 46).

Control circuitry 26 may dynamically adjust the location, size, resolution, or shape of gaze area 46 and peripheral area 50 during operation of glasses 14. For example, control circuitry 26 may use gaze tracking system 24 to track a user's gaze and may adjust the location of gaze area 46 so that it remains aligned with the user's gaze. As shown in FIG. 2, for example, lens 22 may shift the location of the clear foveated region from gaze location 46 to gaze location 46′ to follow the user's gaze. If desired, the size of gaze area 46 may be based on the size of the foveal region in a user's eyes, the user's pupil diameter, and/or the desired phase profile for gaze area 46. Gaze area 46 may, for example, have a diameter D between 4 mm and 9 mm, between 7 mm and 9 mm, between 6 mm and 10 mm, between 4 mm and 8 mm, between 8 mm and 12 mm, greater than 10 mm, less than 10 mm, or any other suitable size. The size of gaze area 46 may be based on a distance between lens components 22 and a user's eyes 16, may be based on the size of the user's pupil 52 (e.g., as measured with sensor system 24 or as inferred based on eye charts, ambient light levels, or other data), and/or may be based on other information.

As used herein, “foveated” region may refer to any size region of lenses 22 that aligns with the user's gaze. The size of region 46 need not be matched to the size of a pupil, if desired. The size of foveated region 46 may, for example, be based on the accuracy of gaze prediction, the current viewing conditions, the visual field angle perceived by the user, and/or other factors.

In gaze area 46, lenses 22 may have a fixed index of refraction to obtain clear (undiffused) lenses. In peripheral area 50, lenses 22 may have a pseudorandom and variable refractive index to diffuse light in different directions and reduce contrast in the user's peripheral vision. This may be achieved by applying appropriate voltage profiles across electrode arrays in lenses 22. For example, a fixed voltage may be applied across electrodes that pass through gaze area 46, while a pseudorandom set of different voltages may be applied across electrodes that pass through peripheral area 50. This creates a clear, undiffused lens in gaze area 46 while reducing contrast in peripheral area 50. In a microlens array arrangement, microlenses in gaze area 46 may be controlled to pass light unaltered (e.g., without diffraction), while microlenses in peripheral region 50 may be used to refocus light in front of the retina (a mechanism sometimes referred to as myopic defocus). If desired, lenses 22 may be bifocal or progressive lenses that bias power in the upper field of vision relative to the lower field of vision for distance viewing and near viewing to reduce step changes and reduce power consumption.

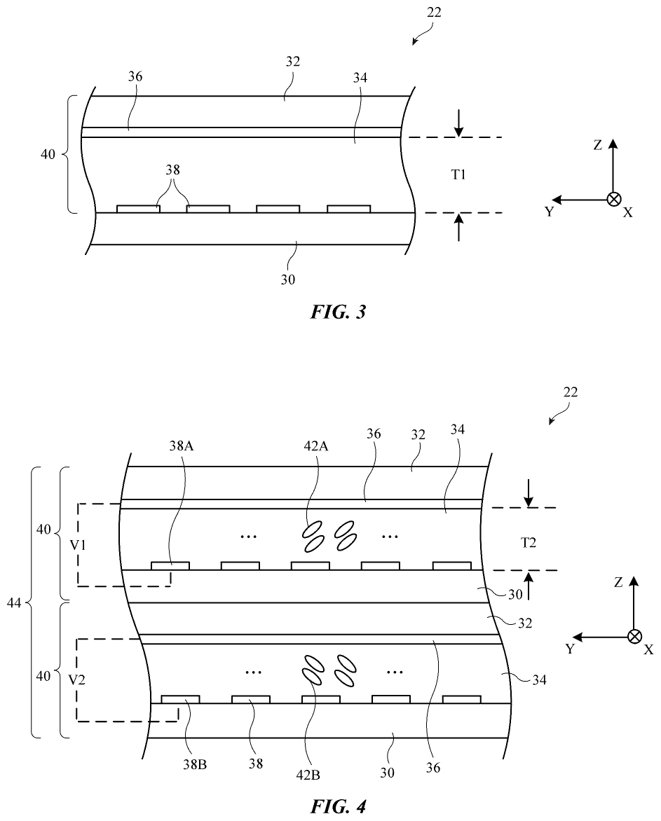

A cross-sectional side view of an illustrative adjustable lens component is shown in FIG. 3. As shown in FIG. 3, component 22 may include liquid crystal cell 40. Liquid crystal cell 40 may have a layer of voltage-modulated optical material such as liquid crystal layer 34 (e.g., twisted nematic liquid crystal, electrically controlled birefringence nematic liquid crystal, polymer-dispersed liquid crystal, or other suitable liquid crystal). Liquid crystal layer 34 may be interposed between transparent substrates such as upper substrate 32 and lower substrate 30. Substrates 32 and 30 may be formed from clear glass, sapphire or other transparent crystalline material, cellulose triacetate, transparent plastic, or other transparent layers. Component 22 may have a pattern of electrodes that can be supplied with signals from control circuitry 26 to produce desired voltages on component 22. In the example of FIG. 3, these electrodes include elongated electrodes (e.g., strip-shaped electrodes) such as electrodes 38 on substrate 30 that run along the X dimension and a common electrode such as common electrode 36 on substrate 32 (e.g., a blanket layer of conductive material on substrate 32). Electrodes 36 and 38 may be formed from transparent conductive material such as indium tin oxide, conductive polymers such as poly(3,4-ethylenedioxythiophene) polystyrene sulfonate (PEDOT:PSS), or other transparent electrode structures and may be located on outer and/or inner surfaces of substrates 32 and 30.

At each location of electrode strips 38 in component 22, a desired voltage may be applied across liquid crystal layer 34 by supplying a first voltage to electrode 38 and a second voltage (e.g., a ground voltage) to common electrode 36. The liquid crystal between the two electrodes will receive an applied electric field with a magnitude that is proportional to the difference between the first and second voltages on the electrodes. By controlling the voltages on electrodes 38 and common electrode 36, the index of refraction of liquid crystal layer 34 of component 22 can be dynamically adjusted to produce customized lenses.

In the example of FIG. 3, strip-shaped electrodes 38 (sometimes referred to as finger electrodes, patterned electrodes, etc.) extend parallel to the X-axis. This allows the index-of-refraction profile (sometimes referred to as the phase profile) of liquid crystal cell 40 to be modulated in the Y-dimension by applying the desired voltages to each finger electrode 38.

When an electric field is applied to the liquid crystals of layer 34, the liquid crystals change orientation. The speed at which a given liquid crystal material can be reoriented is limited by factors such as the thickness of layer 34 (e.g., thickness T1 of FIG. 3, sometimes referred to as the cell gap). To increase the tuning speed of liquid crystal layer 34 while still achieving a suitable tuning range, adjustable lens component 22 may include two or more liquid crystal cells 40 stacked on top of one another. This type of arrangement is illustrated in FIG. 4.

As shown in FIG. 4, adjustable lens component 22 may include liquid crystal module 44. Liquid crystal module 44 may include two or more liquid crystal cells 40. Each liquid crystal cell may include liquid crystal layer 34 interposed between upper substrate 32 and lower substrate 30. Finger electrodes 38 may be formed on each lower substrate 30 and may extend parallel to the X-axis. Common electrode 36 may be formed on each upper substrate 32. If desired, common voltage electrode 36 may be formed on lower substrate 30 and finger electrodes 38 may be formed on upper substrate 32. The example of FIGS. 3 and 4 is merely illustrative.

The cell gap of each liquid crystal cell 40 in module 44 may be less than that of liquid crystal cell 40 of FIG. 3. For example, liquid crystal layers 34 of module 44 in FIG. 4 may each have a thickness T2, which is less than thickness T1 of liquid crystal layer 34 in cell 40 of FIG. 3. The reduced cell gap increases the tuning speed of liquid crystal layers 34 while still maintaining satisfactory tuning range (sometimes referred to as tunable phase depth).

If desired, the liquid crystal alignment orientation (sometimes referred to as a rubbing direction) of liquid crystal cells 40 in module 44 may be antiparallel. In particular, liquid crystal molecules 42A of upper liquid crystal cell 40 may have a first liquid crystal alignment orientation, and liquid crystal molecules 42B of lower liquid crystal cell 40 may have a second liquid crystal alignment orientation that is antiparallel to the first liquid crystal alignment orientation. This type of arrangement may help reduce the angle dependency of phase retardation in module 44.

At each location of finger electrode 38 in component 22, a desired voltage may be applied across each liquid crystal layer 34 by supplying a first voltage to finger electrode 38 and a second voltage (e.g., a ground voltage) to common electrode 36. The liquid crystal between the two electrodes will receive an applied electric field with a magnitude that is proportional to the difference between the first and second voltages on the electrodes. By controlling the voltages on electrodes 38 and common electrode 36, the index of refraction of each liquid crystal layer 34 of component 22 can be dynamically adjusted to produce customized lenses. Because finger electrodes 38 extend along the X-dimension, the phase profile of each liquid crystal cell 40 may be modulated in the Y-dimension by applying the desired voltages to each finger electrode 38.

Overlapping portions of the two liquid crystal layers 34 in module 44 may be controlled using the same or different voltages to achieve the desired index of refraction at that portion of module 44. For example, finger electrode 38A of upper liquid crystal cell 40 in module 44 may overlap finger electrode 38B of lower liquid crystal cell 40 in module 44. A first voltage V1 may be applied across a portion of upper liquid crystal layer 34 overlapping finger electrode 38A, and a second voltage V2 may be applied across a portion of lower liquid crystal layer 34 overlapping finger electrode 38B. Voltages V1 and V2 may be different or may be the same. Control circuitry 26 may determine the ratio of V1 to V2 based on the desired index of refraction at that portion of the liquid crystal module 44 and based on the disposition of the user's eyes 16.

In the examples of FIGS. 3 and 4, adjustable lens component 22 includes electrodes that extend in one direction (e.g., the X-dimension of FIGS. 3 and 4), allowing adjustable lens component 22 to modulate the phase profile of component 22 along one direction (e.g., the Y-dimension of FIGS. 3 and 4). If desired, adjustable lens component 22 may include electrodes that extend in multiple directions, thus allowing adjustable lens component 22 to modulate the phase profile of component 22 along multiple directions.

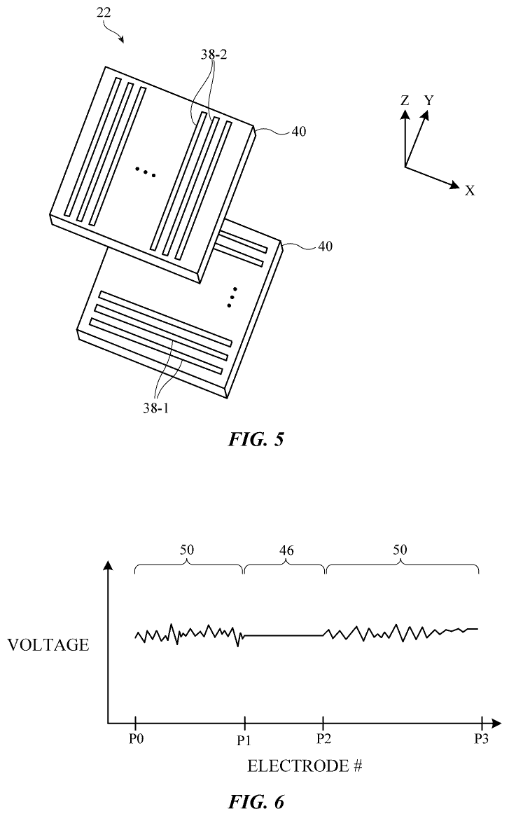

FIG. 5 is a perspective view of illustrative adjustable lens component 22 having a first liquid crystal cell 40 with first finger electrodes 38-1 oriented along a first direction and a second liquid crystal cell 40 with second finger electrodes 38-2 oriented along a second direction different from the first direction. First finger electrodes 38-1 may, for example, be oriented at 90-degree angles relative to second finger electrodes 38-2, or other suitable orientations may be used. Each set of electrodes may modulate the phase profile of a liquid crystal layer along an associated dimension. Adjustable lens component 22 of the type shown in FIG. 5 with two orientations of electrodes may therefore be used to create phase profiles that vary along two dimensions.

Some types of liquid crystal modulate only light of one polarization, leaving light of the other polarization (for example, the polarization direction orthogonal to the rubbing direction in an electrically controlled birefringence cell) largely unmodulated. If desired, additional layers with different rubbing directions (e.g. with rubbing directions at ninety degree angles to each other) can be employed so that both polarizations can be modulated by adjustable lens component 22. Alternatively, a polarizing filter that removes light of the unmodulated polarization can be added to the module.

FIG. 6 is a graph showing an illustrative voltage profile that may be applied across electrodes 38-1 and 38-2 of FIG. 5. As shown in FIG. 6, a pseudorandom array of voltages may be applied to electrodes P0 to P1 and to electrodes P2 to P3. Electrodes P0 to P1 and electrodes P2 to P3 may be located in peripheral regions 50 of lens 22. These electrodes may therefore be used to reduce contrast the user's peripheral vision by diffusing light that passes through liquid crystal cell 40 in those regions. A fixed voltage may be applied to electrodes P1 to P2, or if desired, the voltage applied to electrodes P1 and P2 may vary only slightly, such that the resultant electric fields in the liquid crystal are all subthreshold and do not cause a noticeable phase effect. Electrodes P1 to P2 may be located in gaze region 46 of lens 22. These electrodes may therefore be used to provide a clear, undiffused region through which a user may view external objects such as object 18 (FIG. 1).

Control circuitry 26 may monitor gaze tracking sensor 24 for changes in the user's gaze location. As the user's gaze moves around, control circuitry 26 may adjust the location of foveated clear region 46 and diffused peripheral region 50 on lens 22. Control circuitry 26 may adjust the location of clear region 46 by adjusting which electrodes 38 receive a fixed voltage and which electrodes receive part of a pseudorandom array of voltages. Control circuitry 26 may also monitor additional sensor data from sensors such as sensor 20. If sensor 20 indicates that glasses 14 are being used outside, that glasses 14 are being used while the user is talking to a person, or that glasses 14 are being used to view objects at a distance, control circuitry 26 may apply a fixed voltage across the entire array of electrodes 38 to obtain an entirely clear lens 22 through which the user can view external objects.

If desired, lens components 22 may include more than two liquid crystal cells 40 and more than two electrode orientations. For example, lens components 22 may include three liquid crystal cells 40 with three different electrode orientations, four liquid crystal cells 40 with four different electrode orientations, five liquid crystal cells 40 with five different electrode orientations, etc.

If desired, liquid crystal material 34 may have high dispersion and may be configured to diffuse or refract blue light more than red light in the user's peripheral vision (e.g., in regions 50). Arrangements in which liquid crystal material 34 preferentially diffuses or refracts light in a given direction (e.g., a radial direction or a tangential direction) in order to help focus light in front of the retina may also be used, if desired.

In arrangements of the type shown in FIG. 5, each liquid crystal cell 40 includes finger electrodes 38 (e.g., patterned strip-shaped finger electrodes) and a blanket common electrode 36. With this type of arrangement, control circuitry 26 may be configured to apply a one-dimensional voltage profile across each liquid crystal layer 34. For example, strip-shaped electrodes 38-1 (sometimes referred to as finger electrodes, patterned electrodes, etc.) extend parallel to the X-axis, thereby allowing the index-of-refraction profile (sometimes referred to as the phase profile) of that liquid crystal cell 40 to be modulated in the Y dimension. Electrodes 38-2 extend parallel to the Y-axis, thereby allowing the index-of-refraction profile of that liquid crystal cell 40 to be modulated in the X dimension.

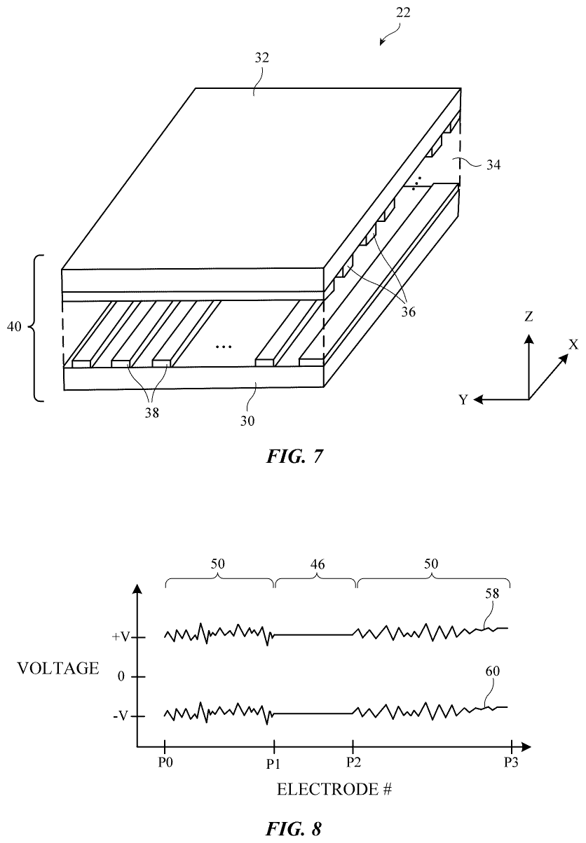

In other arrangements, both the upper and lower arrays of electrodes in cell 40 may include strip-shaped finger electrodes, forming a grid of orthogonal (or otherwise non-parallel) conductive lines that can be driven at different voltages using a passive matrix addressing scheme. This type of arrangement is illustrated in FIG. 7.

As shown in the example of FIG. 7, finger electrodes 38 may extend along the X dimension on substrate 30, and finger electrodes 36 may extend along the Y dimension on substrate 32. If desired, finger electrodes 38 may extend along the Y dimension on substrate 30, and finger electrodes 36 may extend along the X dimension on substrate 32. The example of FIG. 7 is merely illustrative. Electrodes 36 and 38 may be formed from transparent conductive material such as indium tin oxide, conductive polymers such as poly(3,4-ethylenedioxythiophene) polystyrene sulfonate (PEDOT:PSS), silver nanowires, or other transparent electrode structures and may be located on outer and/or inner surfaces of substrates 32 and 30.

In the example of FIG. 7, electrodes 38 and 36 are oriented at 90 degrees relative to one another. This is merely illustrative. In general, electrodes 38 and 36 may be separated by 60 degrees, 80 degrees, 110 degrees, 130 degrees, 160 degrees, and/or any other suitable angle between 0 degrees and 180 degrees. Arrangements in which electrodes 38 and 36 are orthogonal to one another are sometimes described herein as an illustrative example.

In a passive matrix driving scheme where electrodes 38 and electrodes 36 are patterned finger electrodes extending in two orthogonal (or otherwise non-parallel) directions, control circuitry 26 may be configured to control the phase profile of liquid crystal layer 34 along two dimensions. The voltage at each liquid crystal “pixel” where a given upper electrode 36 overlaps a given lower electrode 38 may be equal to the difference between the voltage applied to that upper electrode 36 and the voltage applied to that lower electrode 38. By controlling the voltages on electrodes 36 and electrodes 38, the index of refraction of liquid crystal layer 34 of component 22 can be dynamically adjusted across two different directions (e.g., the X and Y dimensions of FIG. 7) to produce a clear lens in foveated region 46 and a diffused lens in peripheral region 50 (FIG. 2).

FIG. 8 is a graph showing an illustrative voltage profile that may be applied across electrodes 36 and 38 of FIG. 7. Voltage profile 58 may be applied to electrodes 36. Voltage profile 60 may be applied to electrodes 38. As shown in FIG. 8, a pseudorandom array of voltages may be applied to peripheral electrodes P0 to P1 and to peripheral electrodes P2 to P3. Electrodes P0 to P1 and electrodes P2 to P3 may be located in peripheral regions 50 of lens 22. These electrodes may therefore be used to reduce contrast in the user's peripheral vision by diffusing light that passes through liquid crystal cell 40 in those regions. Electrodes P1 to P2 may be located in gaze region 46 of lens 22. These electrodes may therefore be used to provide a clear, undiffused region through which a user may view external objects such as object 18 (FIG. 1). A fixed voltage may be applied to electrodes P1 to P2, or if desired, the voltage applied to electrodes P1 and P2 can vary only slightly, such that the resultant electric fields in the liquid crystal are all subthreshold and do not cause a noticeable phase effect. The presence of some subthreshold variations in foveated region 46 may help avoid the appearance of a prominent vertical and horizontal strip in foveated region 46 while still maintaining a clear region in lens 22. As shown in FIG. 8, voltage profile 58 may be the inverse of voltage profile 60 (e.g., electrodes 36 in locations P1 to P2 may receive positive voltage +V while electrodes 38 in locations P1 to P2 may receive negative voltage −V). Voltages +V and −V in FIG. 8 are merely illustrative. If desired, voltage profile 58 may not be inverse of voltage profile 60 (e.g., electrode 36 in locations P1 to P2 may receive positive voltage +V_1 while electrodes 38 in locations P1 to P2 may receive negative voltage −V_2).

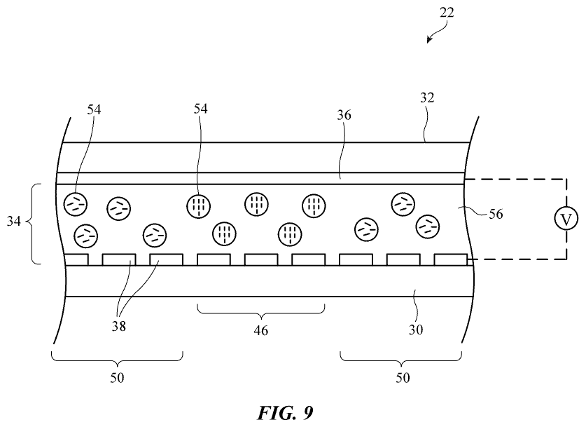

In the example of FIG. 9, liquid crystal layer 34 is formed from polymer-dispersed liquid crystal material. As shown in FIG. 9, liquid crystal layer 34 may include liquid crystal droplets 54 dispersed in a host layer such as host layer 56 (e.g., a polymer matrix) between transparent substrates 32 and 30. Transparent conductive materials such as electrodes 36 and 38 (e.g., indium tin oxide or other transparent conductive material) may be formed on substrates 32 and 30, respectively, to control the behavior of liquid crystal droplets 54. Control circuitry 26 may apply a voltage profile across electrodes 38 to control the orientation of the liquid crystal material in droplets 54. For example, when no voltage is applied across electrodes 38 in peripheral regions 50, liquid crystal droplets 54 may have a random orientation and may therefore be diffusive (e.g., hazy). In gaze region 46, a voltage is applied across electrodes 38 to align liquid crystal droplets 54 and create a clear foveated region with little to no haze. As the user's gaze moves around, control circuitry 26 may adjust which pixels (e.g., electrodes) are turned off (and therefore diffusive) and which electrodes are turned on (and therefore clear).

Electrode 36 may be a blanket common electrode and electrodes 38 may be an array of finger electrodes (e.g., similar to the electrode arrangement of FIG. 5), or electrodes 36 and electrodes 38 may be first and second sets of orthogonal electrode arrays in a passive matrix addressing scheme (e.g., similar to the arrangement of FIG. 7). Arrangements in which electrode 36 is a blanket common electrode and electrodes 38 are an array of pixelated electrodes (e.g., rectangular electrodes, hexagonal electrodes, circular electrodes, and/or other pixelated electrodes) may also be used. If pixelated electrodes are not desired, an alternative driving scheme for polymer-dispersed liquid crystal cells is to have linear arrangements of transparent electrodes 38 as illustrated in FIGS. 5 and 7, coupled with a driving scheme where voltages in gaze region 46 are greater in magnitude than in peripheral regions 50.

When using a polymer-dispersed liquid crystal material, electrodes 38 may be arranged in a two-dimensional pixelated configuration, if desired. The pitch between pixels may be between 1.5 mm and 2.5 mm, between 2 mm and 3 mm, between 1 mm and 2 mm, less than 1 mm, more than 3 mm, or any other desired pitch. The arrangement of these pixelated electrodes can be a square or rectangular regular array, a regular hexagonal array, a distorted hexagonal or rectangular array, an irregular tessellation, or any other desired configuration.

If desired, liquid crystal material 34 may have high dispersion and may be configured to diffuse or refract blue light more than red light in the user's peripheral vision (e.g., in regions 50). Arrangements in which liquid crystal material 34 preferentially diffuses or refracts light in a given direction (e.g., a radial direction or a tangential direction) in order to help focus light in front of the retina may also be used, if desired.

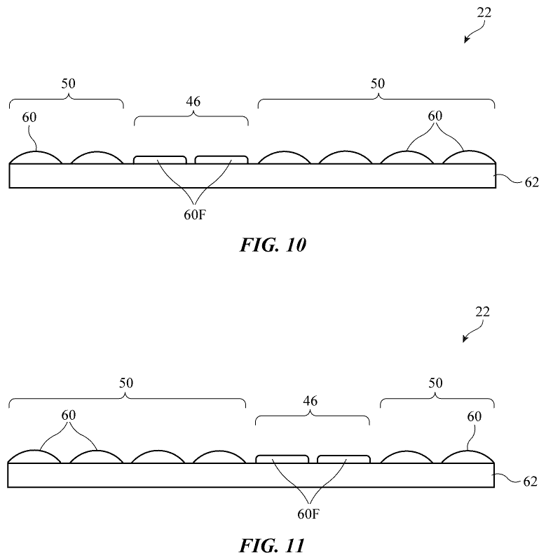

FIGS. 10 and 11 show an illustrative arrangement in which lens components 22 include an adjustable microlens array. As shown in FIG. 10, lens 22 may include a two-dimensional array of adjustable microlenses such as microlenses 60 on substrate 62. Substrate 62 may be a layer of transparent glass, plastic, ceramic, or other suitable material. Microlenses 60 may include liquid crystal microlenses or other tunable microlenses. In peripheral regions 50, microlenses 60 may have a pseudorandom array of different lens powers to help create defocus the user's peripheral vision. In gaze region 46, microlenses 60F may have a fixed lens power (e.g., zero lens power) to provide a clear region through which the user can view external objects. As shown in FIG. 11, control circuitry 26 may actively switch which microlenses 60F are optically flat (e.g., with zero optical power) and which microlenses 60 are provided with an array of different microlens powers to defocus light in regions 50.

Microlenses 60 may be electrowetting tunable lenses (sometimes referred to as droplet lenses), or microlenses 60 may be tunable liquid crystal lenses or adjustable microlenses based on other voltage-tunable optical material. In a liquid crystal microlens, liquid crystal material is contained within a cladding and electrodes are used to apply an electric field to the liquid crystal material. When no voltage is applied (e.g., to microlenses 60F in foveal region 46), the refractive index of the liquid crystal material is matched to the refractive index of the cladding, such that light passes through microlenses 60F without being refracted. When a voltage is applied (e.g., to microlenses 60 in peripheral region 50), the difference in refractive index between the liquid crystal material and the cladding adds an optical power to microlenses 60 (e.g., light is refracted as it passes through microlenses 60).

Some of the figures include cross-sectional views and may or may not include oblique hatching. The oblique hatching in a cross-sectional diagram may be omitted in some instances to avoid impeding a clear reading of the reference signs and leading lines.

The foregoing is merely illustrative and various modifications can be made to the described embodiments. The foregoing embodiments may be implemented individually or in any combination.

What is claimed is:

1. Eyeglasses, comprising:
a supporting frame;
a gaze tracking sensor coupled to the supporting frame and configured to track a gaze location; and
first and second lenses coupled to the supporting frame, wherein each of the first and second lenses comprises:
a clear foveated region that aligns and moves with the gaze location, and
a peripheral region surrounding the clear foveated region, wherein light that passes through the peripheral region is selected from the group consisting of: refocused light and diffused light.

2. The eyeglasses defined in claim 1 wherein the first and second lenses each comprise liquid crystal material.

3. The eyeglasses defined in claim 2 wherein the liquid crystal material is selected from the group consisting of: twisted nematic liquid crystal material, polymer-dispersed liquid crystal material, and electrically controlled birefringence nematic liquid crystal.

4. The eyeglasses defined in claim 2 wherein the liquid crystal material is configured to preferentially diffuse light in a direction selected from the group consisting of: a tangential direction and a radial direction.

5. The eyeglasses defined in claim 2 wherein the liquid crystal material is configured to diffuse blue light more than red light in the peripheral region.

6. The eyeglasses defined in claim 2 wherein the liquid crystal material is sandwiched between a blanket common electrode and an array of finger electrodes.

7. The eyeglasses defined in claim 2 wherein the liquid crystal material is sandwiched between a first array of electrodes extending in a first direction and a second array of electrodes extending in a second direction that is orthogonal to the first direction.

8. The eyeglasses defined in claim 2 wherein the liquid crystal material is sandwiched between a blanket common electrode and an array of pixelated electrodes.

9. The eyeglasses defined in claim 1 wherein the first and second lenses each comprise an array of adjustable microlenses and wherein the array of adjustable microlenses is adjusted based on the gaze location.

10. The eyeglasses defined in claim 1 wherein the first and second lenses each comprise liquid crystal material that is controlled by an array of electrodes, the eyeglasses further comprising control circuitry configured to apply a voltage profile across the array of electrodes, and wherein the voltage profile includes a pseudorandom array of different voltages in the peripheral region and a fixed voltage in the clear foveated region.

11. A lens, comprising:
first and second transparent substrates;
liquid crystal material interposed between the first and second transparent substrates; and
a first electrode on the first transparent substrate and an array of second electrodes on the second transparent substrate, wherein the first electrode and the array of second electrodes are configured to apply an electric field to the liquid crystal material to create a clear foveated region and a diffused peripheral region surrounding the clear foveated region.

12. The lens defined in claim 11 wherein the first electrode is a blanket common electrode.

13. The lens defined in claim 11 wherein the first electrode is part of an array of first electrodes on the first transparent substrate and wherein the first electrodes are orthogonal to the second electrodes.

14. The lens defined in claim 11 wherein the liquid crystal material is selected from the group consisting of: twisted nematic liquid crystal material, polymer-dispersed liquid crystal material, and electrically controlled birefringence nematic liquid crystal.

15. The lens defined in claim 11 wherein the liquid crystal material is configured to preferentially diffuse light in a direction selected from the group consisting of: a tangential direction and a radial direction.

16. The lens defined in claim 11 wherein the liquid crystal material is configured to diffuse blue light more than red light in the diffused peripheral region.

17. A pair of glasses, comprising:
a left adjustable lens; and
a right adjustable lens, wherein the first and second adjustable lenses each have a clear foveated region surrounded by a peripheral region, and wherein light passes through the clear foveated region unaltered and passes through the peripheral region altered.

18. The pair of glasses defined in claim 17 further comprising a gaze tracking sensor configured to track a gaze location, wherein the clear foveated region follows the gaze location.

19. The pair of glasses defined in claim 17 wherein the first and second adjustable lenses each comprise a switchable liquid crystal diffuser that diffuses the light that passes through the peripheral region.

20. The pair of glasses defined in claim 17 wherein the first and second adjustable lenses each comprise an array of adjustable microlenses that refocuses the light that passes through the peripheral region.
